(19) United States
(12) Patent Application Publication
(10) Pub. No.: US 2010/0162038 A1
(43) Pub. Date: Jun. 24, 2010

(54) Nonvolatile/Volatile Memory Write System and Method

(76) Inventors: Jared E Hulbert, Shingle Springs, CA (US); John C. Rudelic, Folsom, CA (US); Hongyu Wang, Shanghai (CN)

Correspondence Address: LEMOINE PATENT SERVICES, PLLC, PO BOX 307, LONG LAKE, MN, 55356-0307, US

(21) Appl. No.: 12/343,485

(22) Filed: Dec. 24, 2008

(51) Int. Cl. G06F 11/20; G06F 12/10; G06F 12/12

(52) U.S. Cl. 714/5; 711/6; 711/103; 711/E12.069; 711/E12.059

(57) ABSTRACT

Methods and systems provide memory handling for memory systems with mixed volatile and nonvolatile memory types. In various embodiments, the method or system maintains a page table that marks memory pages in nonvolatile memory as write-protected. When a write is attempted to a write-protected page in nonvolatile memory, a fault is generated. In response to the fault, memory contents of the write-protected nonvolatile page are moved to a page location in a volatile memory.

### FIELD

The present invention relates generally to memory systems, and more specifically to systems that manage combinations of nonvolatile memory and volatile memory.

### BACKGROUND

Write operations to nonvolatile memories can take longer than write operations to volatile memory. For example, a write operation in FLASH nonvolatile memory can take significantly more time than a write operation in a dynamic random access memory (DRAM) or a static random access memory (SRAM). This presents a challenge to system designers wishing to incorporate nonvolatile memory devices, in part because system software may expect memory writes to always occur very fast.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a computing architecture in accordance with various embodiments of the present invention;

FIGS. 2-4 memory contents of a virtual memory system in accordance with various embodiments of the present invention;

FIGS. 5 and 6 show flow diagrams of methods in accordance with various embodiments of the present invention; and

FIGS. 7 and 8 show diagrams of electronic systems in accordance with various embodiments of the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

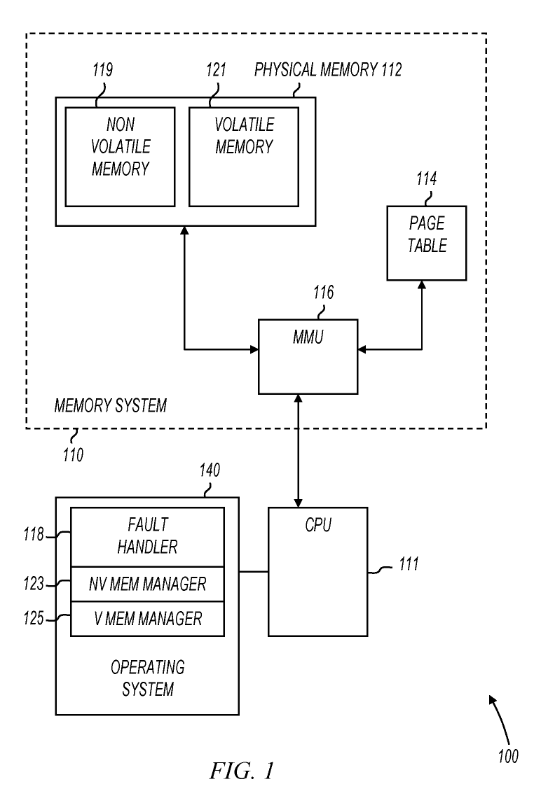

FIG. 1 shows a computing architecture 100 that includes a memory system 110 and a central processing unit (CPU) 111. The CPU 111 is an electrical machine that executes computer programs or software, e.g. a microprocessor. For example, CPU 111 may be a processor available from INTEL Corp. of Santa Clara, Calif. or AMD of Sunnyvale, Calif. Also for example, CPU 111 may include a processor core included within an application specific integrated circuit (ASIC) or may be a digital signal processor. The CPU 111 executes a sequence of stored instructions such as fetch, decode, execute, and writeback instructions. The writeback instruction is also referred to as a write instruction that writes the results of the execute to either local memory or cache, or to main memory such as memory system 110.

Memory system 110 includes physical memory 112 and memory management unit (MMU) 116. Physical memory 112 includes both nonvolatile memory 119 and volatile memory 121. The nonvolatile memory 119 is memory that does not require power to maintain the data stored in the memory. In some embodiments, nonvolatile memory 119 is FLASH memory that is written and erased one page at a time. A page of memory is a plurality of cells, with each cell in the page being addressed at a single time. A cell is the base unit that stores data either as a single bit, i.e., a “0” or a “1” or as a multilevel cell that can store more than one bit. In some embodiments, nonvolatile memory 119 is a NOR FLASH memory, and in other embodiments, nonvolatile memory 119 is a NAND FLASH memory. The volatile memory 121 may be random access memory such DRAM, SRAM, DDR-RAM, or other memory types.

In some embodiments, nonvolatile memory 119 includes phase change memory (PCM). Phase change memories are memories that store information based on modifiable material properties, such as whether a material is in a crystalline or amorphous state (phase). For example, in some embodiments, phase change memories include alloys of elements of group V1 of the periodic table, such as Te or Se, that are referred to as chalcogenides or chalcogenic materials. Chalcogenides may be used advantageously in phase change memory cells to provide data retention and remain stable even after the power is removed from the nonvolatile memory. Taking the phase change material as Ge₂Sb₂Te₅ for example, two phases or more are exhibited having distinct electrical characteristics useful for memory storage. Phase change memory may be referred to as a Phase Change Memory (PCM), Phase-Change Random Access Memory (PRAM or PCRAM), Ovonic Unified Memory (OUM) or Chalcogenide Random Access Memory (C-RAM).

Memory system 110 also includes page table 114. Page table 114 is a virtual memory construct that maps virtual memory pages to physical memory page locations within nonvolatile memory 119 and volatile memory 121. In operation, MMU 116 performs translations between virtual memory addresses and physical memory addresses using page table 114. Virtual memory provides an application being run on the CPU with contiguous working memory when in fact the corresponding physical memory 112 may not be contiguous. The use of virtual memory makes for more efficient programming and improves the use of physical memory 112. Although page table 114 is shown separate from physical memory 112, in some embodiments, the page table is maintained as a data structure in the physical memory.

Memory management unit (MMU) 116 is coupled to communicate with CPU 111, physical memory 112, and page table 114. The memory management unit 116 may include both hardware and software to manage virtual memory, translate between virtual memory addresses and physical memory addresses, provide memory protection, control cache, arbitrate bus usage, etc.

Central processing unit 111 executes application software as well as an operating system 140. Operating system 140 is shown including fault handler 118, nonvolatile memory manager 123, and volatile memory manager 125. Operating system 140 also includes many other components that are not shown in FIG. 1. Although operating system 140 is shown separate from physical memory 112, in some embodiments, operating system 140 is maintained as instructions stored in the physical memory.

Fault handler 118 is a computer program product that includes instructions executable by CPU 111. In general, fault handler 118 causes CPU 111 to perform certain actions when a “fault” occurs. For example, fault handler 118 may be executed when MMU 116 determines that a command from CPU 111 conflicts with memory properties. In some embodiments, the MMU 116 determines that the processor is issuing a write operation to a write-protected memory location and issues a fault to CPU 111. The fault causes fault hander 118 to begin execution and to carry out a memory management process that is more fully explained below. In some embodiments, fault handler 118 corrects for the fault in a manner that is invisible to any application software running on the CPU 111.

A nonvolatile memory manager 123 and a volatile memory manager 125 are in communication with fault handler 118. The nonvolatile memory manager 123 controls movement of pages of data into and out of the nonvolatile memory 119. The volatile memory manager 125 controls movement of pages of data into and out of the volatile memory 121. Memory managers 123 and 125 are computer program products that are executed by CPU 111. In some embodiments, fault handler 118, nonvolatile memory manager 123, and volatile memory manager 125 are combined in a single computer program product in the form of instructions stored on a computer-readable medium. For example, the computer program product(s) may be stored in a memory within CPU 111, or may be stored elsewhere in memory system 110.

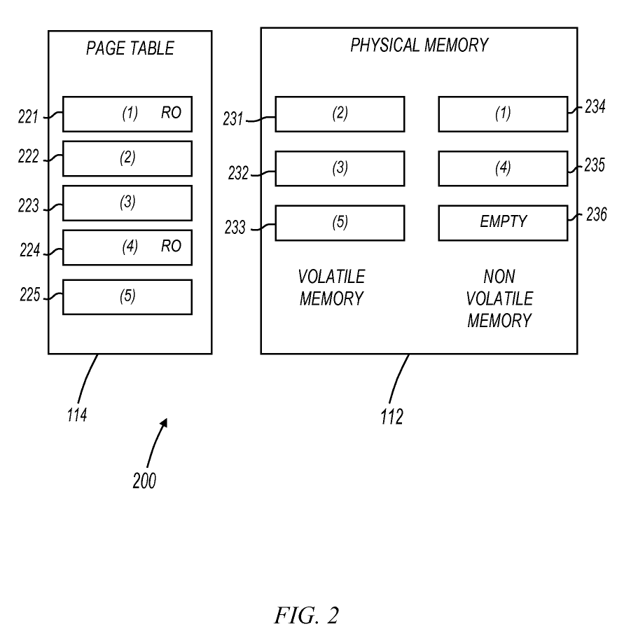

FIG. 2 shows memory contents of a virtual memory system in accordance with various embodiments of the invention. Virtual memory system 200 includes physical memory 112 and page table 114. The physical memory 112 includes both volatile memory and nonvolatile memory, where each of these memories includes a plurality of page locations, at least one of which is marked as read-only. A page location marked as read-only is also referred to herein as being “write-protected”. In various embodiments, the read-only or write-protected page locations are in the nonvolatile memory. In various embodiments, all of the page locations of the nonvolatile memory are write-protected. Write-protected pages can not be written to directly from the processor. If the processor attempts to write to a read-only page location, a fault is issued by a memory management unit, and fault handling is performed. FIGS. 2-4 represent memory contents during a fault handling sequence caused by such a write request.

As shown in FIG. 1, page table 114 includes a table of virtual pages, here shown including pages (1)-(5) with reference numbers 221-225, which correspond to pages (1)-(5) of the physical memory 112. The memory contents of pages (1)-(5) are physically stored in page locations 234, 231, 232, 235, and 233, respectively. The nonvolatile memory further includes an empty page location 236. Here virtual pages 221 and 224 correspond to physical pages in locations 234 and 235, which are in nonvolatile memory and hence are write-protected. The write-protection is accomplished by the read only (RO) attribute in the page table. It will be understood that the virtual memory pages can be mapped to correspond to any of the physical page locations. In operation, the processor (not shown in FIG. 2) issues a write instruction to the virtual memory, which in turn maps the write instruction to the physical location.

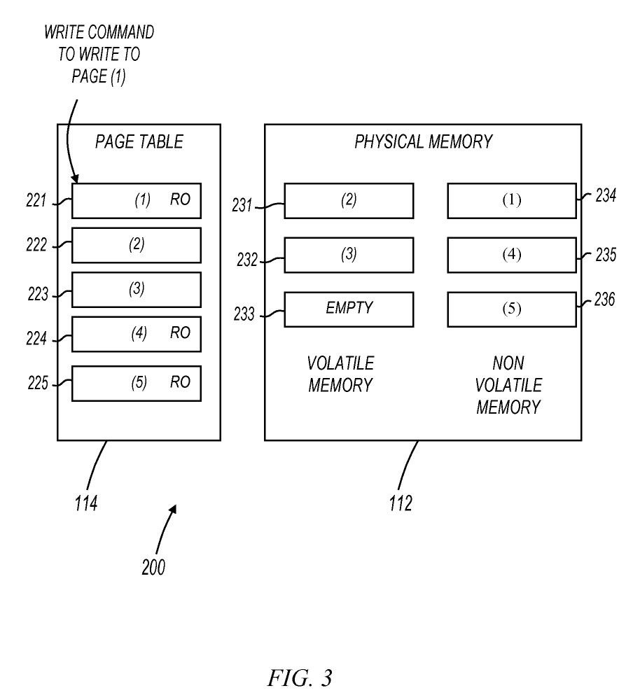

FIG. 3 shows contents of a virtual memory system representing partial results of a write command to a read-only virtual memory page. A write command is received that is to write data to page 221 of the page table 114, which corresponds to the physical page at location 234 of nonvolatile memory. However, this location is a write-protected page. A fault is generated by the MMU (116 in FIG. 1). Fault handler 118 (FIG. 1) is then triggered, and works in cooperation with the nonvolatile and volatile memory managers (123 and 125 in FIG. 1) to correct the fault and enable the write operation.

The volatile memory manager and the nonvolatile memory manager cooperate to move memory contents from page location 233 of volatile memory to the empty page location 236 of nonvolatile memory. The volatile memory manager determines whether or not there is a free page location in the volatile memory. If no free page location is found in the volatile memory, them a page of data is moved out of the volatile memory to nonvolatile memory. In this example, page (5) is moved from location 233 in volatile memory to location 236 in nonvolatile memory. As a result, page location 236 now corresponds to virtual page 225, and page location 233 in volatile memory is now empty to make room for a page that is to accept a write. Page table 114 is updated to reflect that virtual page 225 now corresponds to page 236 and updates the read-only status of page 225 to write-protected as it now corresponds to a physical memory page in nonvolatile memory. In the embodiment shown in FIG. 3, the virtual pages 221, 224, and 225 are now marked as read-only because they correspond to pages located in nonvolatile memory. If the volatile memory manager finds a free location in the volatile memory, then the page movement just described need not take place.

In some embodiments, the volatile memory is managed such that all memory pages in the volatile memory are always full. This increases the likelihood that a write can be accomplished without first moving memory pages, because of the increased likelihood that the location to be written is already in the volatile memory. In embodiments in which volatile memory pages are always kept full, a page is transferred out of volatile memory each time a page is to be transferred in. When pages are moved out of volatile memory, the page to move may be selected using any criteria. For example, in some embodiments, a least recently used (LRU) algorithm is used to select which page of data is to be moved out of volatile memory.

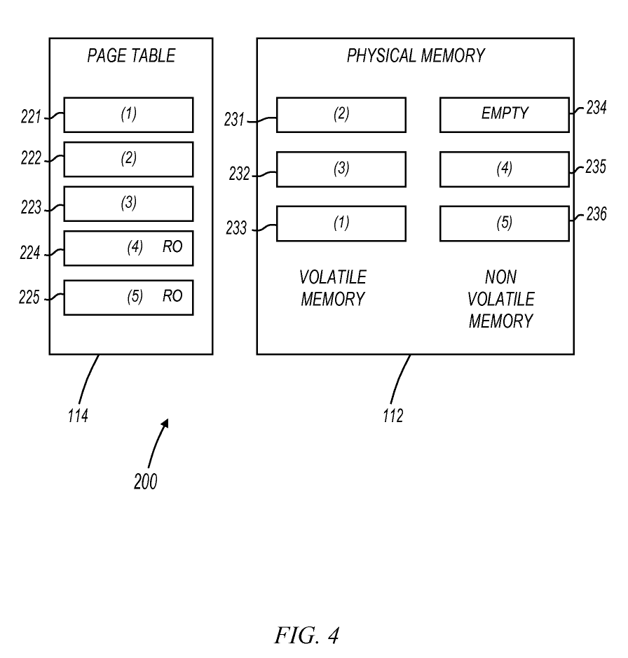

FIG. 4 shows contents of a virtual memory system representing further results of a write command to a read-only virtual memory page. The volatile memory manager and the nonvolatile memory manager cooperate to move data from page location 234 in nonvolatile memory to the now emptied page location 233 in volatile memory. After moving the page of data from nonvolatile memory to volatile memory, physical page location 233 of volatile memory corresponds to virtual page 221 and physical page location 234 is empty. The write operation is now performed by writing the data to the memory contents at physical page location 233 in volatile memory. This write operation appears seamless to any application software running on the processor. The virtual memory fault handling mechanism handles any write requests to nonvolatile memory by moving pages between volatile and nonvolatile memory such that the write can be performed in volatile memory.

When future write commands are received, they are handled in a similar manner. If the virtual memory locations 221, 222, or 223 are to be written to, no fault is generated as these pages are mapped to volatile memory page locations 233, 232, and 231, respectively, and are not marked as read only in page table 114. However, if a write command is received to write to virtual memory locations 224 or 225, then a fault is generated as these pages are mapped to nonvolatile memory page locations 235 and 236, respectively, which are marked as read-only in page table 114, and are write-protected.

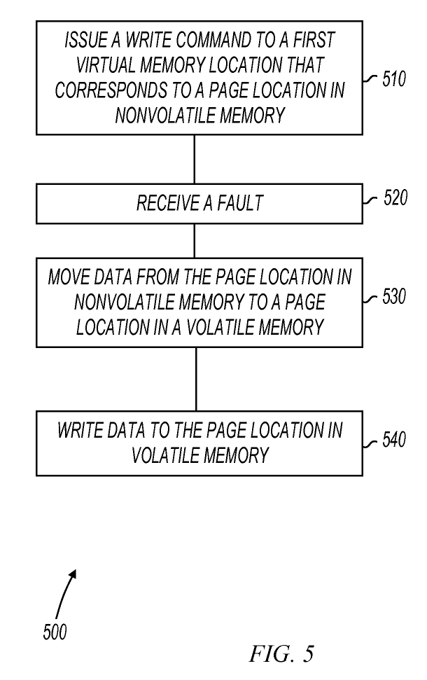

FIG. 5 shows a method according to various embodiments of the invention. In some embodiments, method 500, or portions thereof, is performed by a processor in a system, embodiments of which are shown in previous figures. In other embodiments, all or portions of method 500 are performed by a hardware/software combination in an electronic system. In some embodiments, a computer software product specifies instruction that when executed cause method 500 to be performed. Method 500 is not limited by the particular type of apparatus performing the method. The various actions in method 500 may be performed in the order presented, or may be performed in a different order. Further, in some embodiments, some actions listed in FIG. 5 are omitted from method 500.

Method 500 is shown beginning at block 510 in which a write command is issued to a first virtual memory location that corresponds to a page location in a nonvolatile memory. This may correspond to CPU 111 issuing a write command to a virtual memory location specified in page table 114, where the virtual memory location corresponds to a physical page of memory in nonvolatile memory 119 (FIG. 1). The page in the nonvolatile memory may be marked read-only such as pages (1) and (4) (FIG. 2).

At 520, a fault is received. The fault may be sent by a memory management unit such as MMU 116 (FIG. 1) in response to the attempt to write to nonvolatile memory which is marked in a page table as read-only. In response to the fault, at 530 data is moved from the page location in the nonvolatile memory to a page location in a volatile memory. At this point, the page table is updated to show that the moved page is no longer read-only. At 540, the data is written to the location in the volatile memory.

The fault handling mechanism described in FIG. 5 allows a system to mix volatile and nonvolatile memory in a system without having to make the application software aware of the nonvolatile memory. When a write is issued to a location in nonvolatile memory, fault handling in the operating system takes care of moving memory contents from the nonvolatile memory to a nonvolatile memory, and the write can then go forward.

In some embodiments, fault handling as described in method 500 may be performed by a computer program product such as fault handler 118 (FIG. 1). In other embodiments, the fault handling as described in method 500 may be performed by a computer program product that includes a fault handler and one or more memory managers such as memory managers 123 and 125 (FIG. 1).

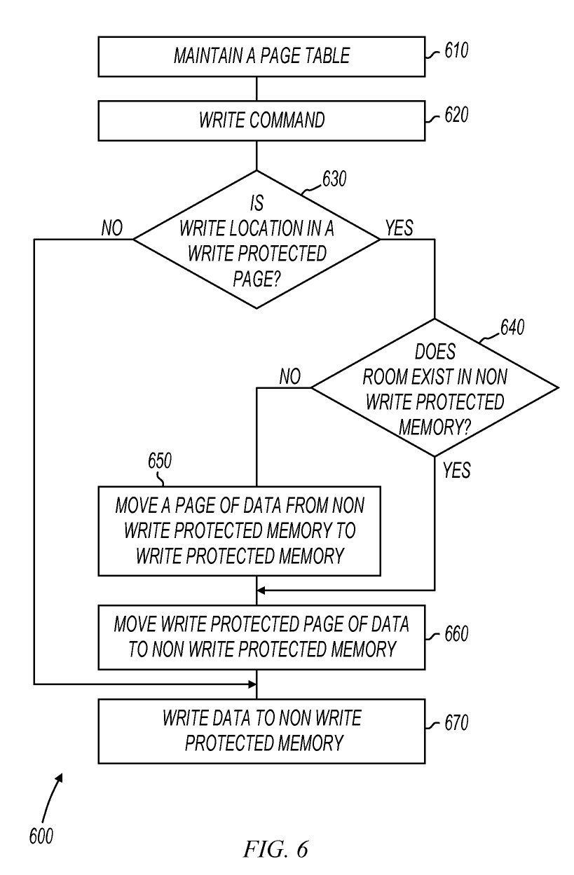

FIG. 6 shows a method according to various embodiments of the invention. In some embodiments, method 600, or portions thereof, is performed by a processor in a system, embodiments of which are shown in previous figures. In some embodiments, a computer software product specifies instruction that when executed cause method 600 to be performed. In other embodiments, all or portions of method 600 are performed by a hardware/software combination in an electronic system. Method 600 is not limited by the particular type of apparatus performing the method. The various actions in method 600 may be performed in the order presented, or may be performed in a different order. Further, in some embodiments, some actions listed in FIG. 6 are omitted from method 600.

Method 600 is shown beginning at block 610 in which a page table is maintained. The page table includes page table entries that map virtual memory addresses to physical memory addresses. Further, the page table has the ability to mark individual virtual pages as read-only. In some embodiments, all virtual pages that correspond to physical pages in nonvolatile memory are marked as read-only. When a page is marked as read-only in the page table, the page location is write-protected. Although the maintenance of the page table is shown in a single block (610) in FIG. 6, various embodiments of the invention update page table entries at appropriate times during the execution of methods. For example, as explained below, a page marked as read-only may be moved from nonvolatile memory to volatile memory. As part of this operation, the page table entry may be updated to no longer be read-only. Also for example, pages moved from volatile memory to nonvolatile memory may be marked as read-only.

At 620 a write command is issued/received to write data to a location. The location is specified by a virtual address. At 630, a determination is made as to whether the location is in a write protected page. In some embodiments, this corresponds to a memory management unit such as MMU 116 (FIG. 1) checking the read-only status of a page table entry. In some embodiment, the write protection is always on page locations stored in non volatile memory, such as NOR-type or NAND-type FLASH memory, or phase change memory (PCM). If the write location is not write-protected, then the method proceeds to 670 where the write takes place. No fault is issued in this case. If the write location is write-protected, then the method moves to 640. In some embodiments, this is due to a fault occurring. For example, the MMU may test the read-only status of the page table entry corresponding to the write location, and if it is marked as read-only, a fault may be generated. In response to the fault, the processor executes a fault handler such as fault handler 118 (FIG. 1).

At 640, a determination is made whether non write-protected memory has room to have a page of data transferred in. In some embodiments, the non write-protected memory is volatile memory such as volatile memory 121 (FIG. 1). This determination may be made by a volatile memory manager in response to a request by a fault manager. If room exists, then method 600 moves to 660 where memory contents of the write-protected page of data are moved to the non write protected memory. If room does not exist, then method 600 moves to 650 where room in the non write protected memory is made by moving a page of data from the non write-protected memory to the write-protected memory.

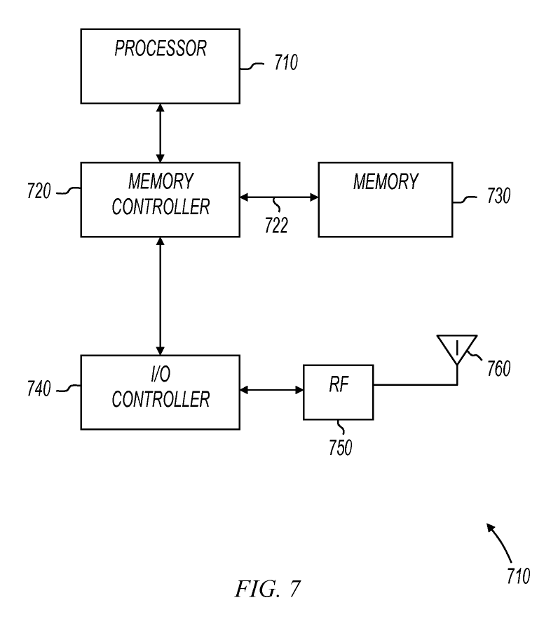

FIG. 7 shows an electronic system in accordance with various embodiments of the present invention. Electronic system 700 includes processor 710, memory controller 720, memory 730, input/output (I/O) controller 740, radio frequency (RF) circuits 750, and antenna 760. In operation, system 700 sends and receives signals using antenna 760, and these signals are processed by the various elements shown in FIG. 7. Antenna 760 may be a directional antenna or an omni-directional antenna. As used herein, the term omni-directional antenna refers to any antenna having a substantially uniform pattern in at least one plane. For example, in some embodiments, antenna 760 may be an omni-directional antenna such as a dipole antenna, or a quarter wave antenna. Also for example, in some embodiments, antenna 760 may be a directional antenna such as a parabolic dish antenna, a patch antenna, or a Yagi antenna. In some embodiments, antenna 760 may include multiple physical antennas.

Radio frequency circuit 750 communicates with antenna 760 and I/O controller 740. In some embodiments, RF circuit 750 includes a physical interface (PHY) corresponding to a communications protocol. For example, RF circuit 750 may include modulators, demodulators, mixers, frequency synthesizers, low noise amplifiers, power amplifiers, and the like. In some embodiments, RF circuit 750 may include a heterodyne receiver, and in other embodiments, RF circuit 750 may include a direct conversion receiver. In some embodiments, RF circuit 750 may include multiple receivers. For example, in embodiments with multiple antennas 760, each antenna may be coupled to a corresponding receiver. In operation, RF circuit 750 receives communications signals from antenna 760, and provides analog or digital signals to I/O controller 740. Further, I/O controller 740 may provide signals to RF circuit 750, which operates on the signals and then transmits them to antenna 760.

Processor 710 may be any type of processing device. For example, processor 710 may be a CPU such as CPU 111 (FIG. 1), a microprocessor, a microcontroller, or the like. Further, processor 710 may include any number of processing cores, or may include any number of separate processors. In some embodiments, processor 710 executes code that performs the functions of fault handler 118 and memory managers 123 and 125.

Memory controller 720 provides a communications path between processor 710 and other devices shown in FIG. 7. In some embodiments, memory controller 720 is part of a hub device that provides other functions as well. As shown in FIG. 7, memory controller 720 is coupled to processor 710, I/O controller 740, and memory 730. In some embodiments, memory controller 720 includes memory management unit 116 and provides faults to the processor when necessary. For example, if processor 710 issues a write command to a write-protected virtual memory page, memory controller 720 may send a fault indication to the processor

Memory controller 720 provides data through bus 722 to memory 730 and receives data from memory 730 in response to read requests. Commands and/or addresses may be provided to memory 730 through conductors other than bus 722 or through bus 722. Memory controller 730 may receive data to be stored in memory 730 from processor 710 or from another source. Memory controller 720 may provide the data it receives from memory 730 to processor 710 or to another destination. Bus 722 may be a bi-directional bus or unidirectional bus. Bus 722 may include many parallel conductors. The signals may be differential or single ended.

Memory controller 720 is also coupled to I/O controller 740, and provides a communications path between processor 710 and I/O controller 740. I/O controller 740 includes circuitry for communicating with I/O circuits such as serial ports, parallel ports, universal serial bus (USB) ports, and the like. As shown in FIG. 7, I/O controller 740 provides a communications path to RF circuits 750.

Memory 730 may be any type of memory technology. For example, memory 730 may be random access memory (RAM), dynamic random access memory (DRAM), static random access memory (SRAM), nonvolatile memory such as FLASH memory, phase change memory (PCM), or any other type of memory. Memory 730 may represent a single memory device or a number of memory devices on one or more memory modules. For example, in some embodiments, memory 730 includes volatile and nonvolatile memory.

Memory 730 also represents a computer-readable medium that has instructions stored that when accessed cause memory controller 720 to perform various method embodiments of the present invention. For example, instructions for either or both of method 500 (FIG. 5) and method 600 (FIG. 6) may be stored in memory 730. Also for example, instructions to implement the functionality of one or more of fault handler 118, nonvolatile memory manager 123, and volatile memory manager 125 may be stored in memory 730. Memory 730 may also store one or more page tables such as page table 114.

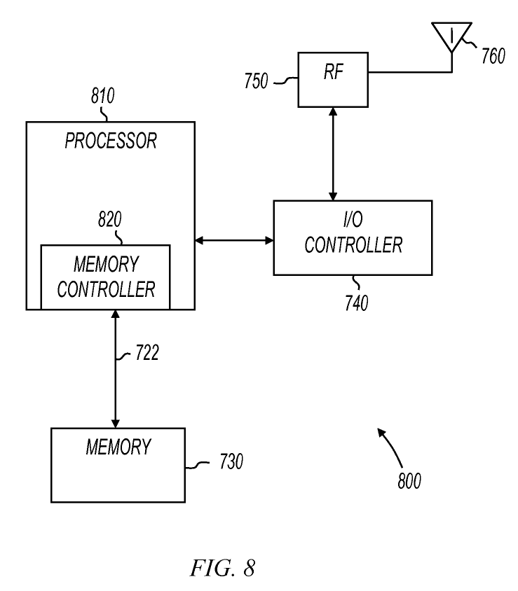

FIG. 8 shows an electronic system in accordance with various embodiments of the present invention. Electronic system 800 includes memory 730, I/O controller 740, RF circuits 750, and antenna 760, all of which are described above with reference to FIG. 7. Electronic system 800 also includes processor 810 and memory controller 820. As shown in FIG. 8, memory controller 820 is included in processor 810. Processor 810 may be any type of processor as described above with reference to processor 710 (FIG. 7). Processor 810 differs from processor 710 in that processor 810 includes memory controller 820, whereas processor 710 does not include a memory controller.

Example systems represented by FIGS. 7 and 8 include desktop computers, laptop computers, cellular phones, personal digital assistants, wireless local area network interfaces, or any other suitable system. Many other systems uses for memories that employ both volatile and nonvolatile memories exist. For example, the various embodiments described herein may be used in a server computer, a network bridge or router, a gaming machine, a casino game, or any other system with or without an antenna.

The systems and methods described herein provide techniques that allow the use of non-volatile memory with little to no affect on performance at the system level. System performance is not degraded as a software call to a driver is not required for every write to memory even though the system includes some non-volatile memory. Use of virtual memory, page tables, fault handlers, and memory managers to manage non-volatile memory allows the software to read and write to memory without needing to be aware of the memory type.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A method comprising:
issuing a write command to write first data to a virtual memory location, wherein the virtual memory location corresponds to a first page location in a nonvolatile memory;
receiving a fault;
moving memory contents from the first page location to a second page location in a volatile memory; and
writing the first data to the second page location in the volatile memory.

2. The method of claim 1 further comprising moving a page of data from the volatile memory to the nonvolatile memory to free space for moving the memory contents to the volatile memory.

3. The method of claim 2 wherein moving memory contents from the first page location includes keeping all page locations within the volatile memory full of data.

4. The method of claim 1 wherein receiving a write command includes receiving a write command to a location within a NAND FLASH memory.

5. The method of claim 1 wherein receiving a write command includes receiving a write command to a location within a NOR FLASH memory.

6. The method of claim 1 wherein receiving a write command includes receiving a write command to a location within a phase change memory.

7. A method comprising:
maintaining a memory page table that represents both volatile memory pages and nonvolatile memory pages;
receiving a write command to write first data to a first memory page;
determining if the first memory page is write-protected;
if the first memory page is write-protected, moving data in the first memory page to a second page location in a volatile memory; and
writing the first data to the second page location.

8. The method of claim 7 wherein moving data in the first memory page comprises issuing a fault and controlling operation of a nonvolatile storage manager based on the fault.

9. The method of claim 8 wherein moving data in the first memory page comprises controlling operation of a volatile storage manager based on the fault.

10. The method of claim 9 wherein moving data in the first memory page comprises determining if a page location is open in the volatile memory and if a page location is not open, then moving data from a page location in the volatile memory to an empty page location in nonvolatile memory.

11. The method of claim 10 wherein maintaining a memory page table comprises updating a write-protected status of any page of data moved between nonvolatile memory and volatile memory.

12. The method of claim 7 further comprising writing the first data to the first page location if the first page location is not write-protected.

13. A computer program product comprising:
a fault handler to receive a fault when a write instruction is issued to write to a first memory page in a write-protected nonvolatile memory; and
at least one memory manager responsive to the fault handler to move data from the first memory page to a non-protected, second page in a volatile memory

14. The computer program product of claim 13 wherein the at least one memory manager comprises a nonvolatile memory manager to manage the nonvolatile memory, and a volatile memory manager to manage the volatile memory.

15. The computer program product of claim 14 wherein the volatile memory manager moves data in the second page if there are no free pages in the volatile memory and a fault is received.

16. The computer program product of claim 13 wherein all memory pages resident in nonvolatile memory are marked as write-protected.

17. A computer-readable medium having instructions stored thereon that when accessed result in a computer performing:
maintaining a memory page table that represents both volatile memory pages and nonvolatile memory pages;
receiving a write command to write first data to a first memory page;
determining if the first memory page is a write-protected page in a nonvolatile memory;
if the first memory page is a write-protected page in a nonvolatile memory, moving data in the first memory page to a second page location in a volatile memory; and
writing the first data to the second page location.

18. The computer-readable medium of claim 17 wherein moving data in the first memory page comprises issuing a fault and controlling operation of a nonvolatile memory manager based on the fault.

19. The computer-readable medium of claim 18 wherein moving data in the first memory page comprises controlling operation of a volatile storage manager based on the fault.

20. The computer-readable medium of claim 17 wherein moving data in the first memory page comprises determining if a page location is open in the volatile memory and if a page location is not open, moving data from a page location in the volatile memory to an empty page location in nonvolatile memory.
